(19) United States
(12) Patent Application Publication
(10) Pub. No.: US 2012/0329506 A1
(43) Pub. Date: Dec. 27, 2012

(54) METHOD FOR TRANSMITTING INFORMATION OF NEIGHBORING BASE STATION IN WIRELESS COMMUNICATION SYSTEM

(75) Inventors: Sung Cheol Chang, Daejeon (KR); Eunkyung Kim, Daejeon (KR); Jae Sun Cha, Daejeon (KR); Soojung Jung, Daejeon (KR); Hyun Lee, Daejeon (KR); Chul Sik Yoon, Daejeon (KR)

(73) Assignee: ELECTRONICS AND TELECOMMUNICATIONS RESEARCH INSTITUTE, Daejeon (KR)

(21) Appl. No.: 13/582,925

(22) PCT Filed: Mar. 4, 2011
(86) PCT No.: PCT/KR2011/001529

§ 371 Date: Sep. 5, 2012

(30) Foreign Application Priority Data
Mar. 5, 2010 (KR) 10-2010-0020095
Mar. 4, 2011 (KR) 10-2011-0019652

(51) Int. Cl. H04B 7/00

(52) U.S. Cl. 455/517

(57) ABSTRACT

Provided is a method for obtaining superframe header (SFH) information in a neighboring base station advertisement (NBR-ADV) message at a terminal. In the method, a NBR-ADV message having SFH information set per each carrier is received from a serving base station. The SFH information of each carrier is obtained from the NBR-ADV message. In the obtaining the SFH information of each carrier, SFH information of a corresponding carrier is obtained based on SFH information of a previous carrier when a predetermined field is set as a predetermined value.

### TECHNICAL FIELD

The present invention relates to a wireless communication system. More particularly, the present invention relates to a method for transmitting information on neighboring base stations to a terminal in a wireless communication system.

### BACKGROUND ART

In a wireless communication system, a serving base station periodically broadcasts a neighbor advertisement (NBR-ADV) message to neighboring base stations. The NBR-ADV message includes network properties of a serving base station and neighboring base stations. A terminal may obtain a neighboring base station index (Neighbor BS Index), a quality of service (QoS) parameter, and channel information from a NBR-ADV message.

A NBR-ADV message is broadcasted after being divided into a plurality of fragmentations. The NBR-ADV message includes a total fragmentation field and a fragmentation index field. The total fragmentation field indicates the total number of fragmentations in the NBR-ADV message. The fragmentation index field denotes a position of a corresponding fragmentation in the NBR-ADV message.

Therefore, a terminal receives fragmentations as many as the total number of fragmentations indicated by the total fragmentation field and then sequentially obtains information on neighboring base stations based on information in the fragmentation index field. A neighbor BS index may be determined based on a sequence of neighbor BS information obtained by the terminal. The terminal and the serving base station can exchange messages using the neighbor BS index.

In order to obtain a neighbor BS index, a terminal needs to receive fragmentations sequentially from the first fragmentation that is a fragmentation having a fragmentation index field value of 0. For example, in order to obtain a neighbor BS index in the fourth fragmentation that is a fragmentation has a fragmentation index field value of 3, a terminal needs to sequentially receive all of first, second, and third fragmentations that have fragmentation field index values of 0, 1, and 2.

### DISCLOSURE

### Technical Problem

The present invention has been made in an effort to provide a method for transmitting information on neighboring base stations from a serving base station to a terminal in a wireless communication system.

### Technical Solution

The present invention has been made in an effort to provide a method for obtaining an index of a neighboring base station in order to transmit and receive messages between a terminal and a serving base station.

The present invention has been made in an effort to provide a method for transmitting information on a superframe header per each carrier in a wireless communication system supporting multi-carrier.

An exemplary embodiment of the present invention provides a method for obtaining superframe header (SFH) information in a neighboring base station advertisement (NBR-ADV) message at a terminal. The method includes receiving a NBR-ADV message having SFH information set per each carrier from a serving base station, and obtaining the SFH information of each carrier from the NBR-ADV message. In the obtaining the SFH information of each carrier, SFH information of a corresponding carrier is obtained based on SFH information of a previous carrier when a predetermined field is set as a predetermined value. Another exemplary embodiment of the present invention provides a method for transmitting a neighboring base station advertisement (NBR-ADV) message at a serving base station supporting multi-carrier. The method includes setting superframe header (SFH) information in the NBR-ADV message, and periodically broadcasting the NBR-ADV message to a terminal. In the setting SFH information, a predetermined field is set as a predetermined value when SFH information of a first carrier is related to SFH information of a second carrier that is a previous carrier of the first carrier. Still another exemplary embodiment of the present invention provides a method for obtaining a neighbor base station (BS) index at a terminal. The method includes receiving a neighboring base station advertisement (NBR-ADV) message from a serving base station, wherein the NBR-ADV message includes cell type information, message segment index information, and at least one of neighboring base station information, and forming a neighbor BS index by combining the cell type information, the message segment index information, and a position of corresponding neighboring base station information.

Yet another exemplary embodiment of the present invention provides a method for obtaining a neighbor base station (BS) index of a service base station. The method includes setting a neighboring base station advertisement (NBR-ADV) message including at least one of cell type information, message segment index information, and neighboring base station information, periodically broadcasting the NBR-ADV message, and forming a neighbor base station (BS) index by combining the cell type information, the message segment index information and a position of neighboring base station information.

### Advantageous Effects

In accordance with an exemplary embodiment of the present invention, a terminal can obtain superframe header information per each carrier. A base station and a terminal can obtain an index of a neighboring base station without additionally using fields in a neighbor advertisement (NBR-ADV) message.

### DESCRIPTION OF THE DRAWINGS

FIG. 1 illustrates transmitting a neighbor advertisement (NBR-ADV) message from a serving base station to a terminal.

FIG. 2 is a flowchart that illustrates a method for transmitting a neighbor advertisement (NBR-ADV) message from a serving base station to a terminal in accordance with an exemplary embodiment of the present invention.

FIG. 3 is a flowchart that illustrates a method for transmitting a neighbor advertisement (NBR-ADV) message from a serving base station to a terminal in accordance with another exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

In the specification, a terminal may denote a mobile station (MS), a mobile terminal (MT), a subscriber station (SS), a portable subscriber station (PSS), a user equipment (UE), and an access terminal (AT). Furthermore, the terminal may include entire or some functions of a mobile station, a mobile terminal, a subscriber station, a portable subscriber station, a user equipment, and an access terminal.

In the specification, a base station (BS) may denote an access point (AP), a wireless access station (RAS), a node-B (NodeB), an evolved node-B, (eNodeB), a base transceiver station (BTS), and a mobile multi-hop relay (MMR)-BS. Furthermore, the base station may include entire or some of functions of an access point, a base station, a wireless access station, a nodeB, an eNodeB, a base transceiver station, and a MMR-BS.

A serving base station periodically broadcasts a neighbor advertisement (NBR-ADV) message in order to inform a terminal of information on basic network configuration (topology). The NBR-ADV message includes system information on a serving base station and neighboring base stations. Based on the NBR-ADV message, the terminal can obtain a neighbor BS index (Neighbor BS Index), a Quality of Service (QoS) parameter, and channel information. The neighbor BS index is identification information on at least one of neighboring base stations included in the NBR-ADV message. Accordingly, the neighbor BS index is different from a BSID that is a unique identifier of a neighboring base station.

In the specification, a method for setting and transmitting a NBR-ADV message to a terminal at a serving base station and a method for obtaining information on a neighboring base station from a NBR-ADV message at a terminal will be described.

Hereinafter, a method for calculating a neighbor BS index based on a NBR-ADV message and a method for transmitting superframe header information by each carrier within a NBR-ADV message when multi-carrier is supported will be described.

At first, a method for calculating a neighbor BS index using a NBR-ADV message will be described.

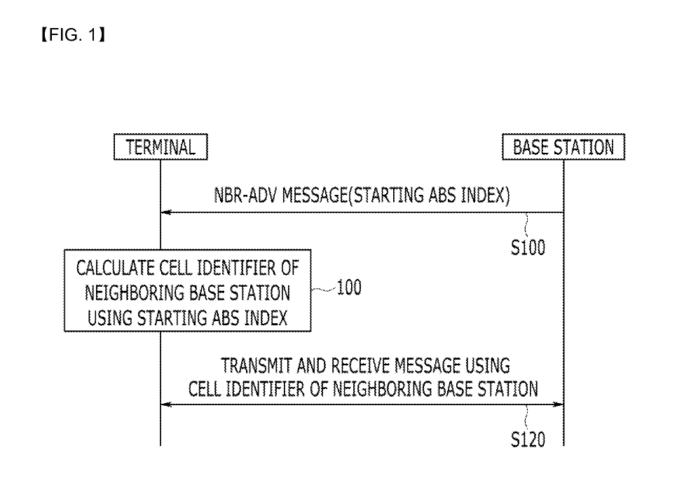

FIG. 1 illustrates transmission of a NBR-ADV message from a serving base station to a terminal.

Referring to FIG. 1, a serving base station periodically broadcasts a NBR-ADV message to a terminal at step S100. The NBR-ADV message may be an AAI_NBR-ADV message divided into a plurality of segments after divided by a cell type.

Table 1 shows a part of the AAI_NBR-ADV message.

TABLE 1

| | Size | | |
|---|---|---|---|
| Field | (bits) | Value/Description | Condition |
| Change Count | 3 | AAI-NBR-ADV Change Count | |
| Total number of | 3 | The total number of cell types | |
| cell types | | | |
| Cell type | 3 | Cell type in this message | |
| | | 0b000: macro | |
| | | 0b001: micro | |
| | | 0b010: macro hotzone | |
| | | 0b011: femto | |
| | | 0b100: TTR relay | |
| | | 0b101: R1 BS or LZone of ABS | |
| | | 0b110-0b111: reserved | |
| Total Number | 4 | Total number of segments of AAI- | |
| of AAI-NBR- | | NBR-ADV | |
| ADV Segments | | | |
| AAI-NBR-ADV | 4 | Indicates current segment index of | |
| Segment Index | | this message in the specific cell | |
| | | type | |
| Starting ABS | 8 | Starting ABS Index is the index | |
| Index | | offset from the last ABS of the | |
| | | previous AAI-NBR-ADV segment. | |
| | | If this is the first AAI-NBR-ADV | |
| | | segment, the Starting ABS Index | |
| | | will be 0. Hence, each AAI-NBR- | |
| | | ADV segment has one Index which | |
| | | corresponds to the first ABS in that | |
| | | AAI-NBR-ADV segment. The | |
| | | order of the ABS within a segment | |
| | | serves as an offset from the | |
| | | ‘Starting ABS index’. The sum of | |
| | | the offset and the ‘Starting ABS | |
| | | index’ serves as the ABS index | |
| | | that has the range of [1 . . . 256]. | |

As shown, the AAI_NBR-ADV message includes a total number of cell type field, a cell type field, a total number of AAI-NBR_ADV segment field, an AAI-NBR_ADV segment field, and a starting neighbor BS index (Starting ABS Index) field.

The cell type may be classified into, for example, a macrocell, a microcell, a macro hotzone, a femtocell, and a relay. Segments having a different cell type may be transmitted after a plurality of segments having the same cell type are transmitted. The total number of cell type field denotes the total number of segments having the same cell type. The AAI-NBR_ADV segment field denotes a position or a sequence of a corresponding segment among the segments having the same cell type. The starting ABS Index field denotes a position or a sequence of a starting neighboring base station of a corresponding segment. That is, a cell identifier of a neighboring base station included in a corresponding segment may be decided in accordance with the starting ABS index field.

The terminal calculates a neighbor BS index using the cell type field, the total number of segments field, the segment index field, and the starting ABS index at step S110.

The terminal and the serving base station exchange messages using the neighbor BS index at step S120. The terminal and the serving base station exchange the following messages: an AAI_SCN-REQ message, an AAI_SCN-RSP message, an AAI_DL-IM broadcast message, an AAI_LBS-ADV message, and an AAI_HO-REQ message. The AAI_SCN-REQ message is a message transmitted by the terminal to the serving base station in order to scan a target base station for handover. The AAI_SCN-RSP message is transmitted by the terminal to the serving base station as a response to the AAI_SCN-REQ message. The AAI_DL-IM broadcast message is a message that the serving base station broadcasts to the terminal in order to decide a fractional frequency reuse (FFR) parameter and a multi input multi output (MIMO) parameter. The AAI_LBS-ADV message is a message broadcasted by a base station supporting a location based service for transmitting information on a LBS. The AAI_HO-REQ message is a message transmitted by the terminal for requesting handover to the serving base station.

As described above, it is necessary to allocate additional resources for the starting ABS field per each segment. Accordingly, the efficiency of the NBR-ADV message is decreased.

In order to overcome such a problem, a method in accordance with an exemplary embodiment of the present invention effectively calculates a neighbor BS index without using the starting ABS index field.

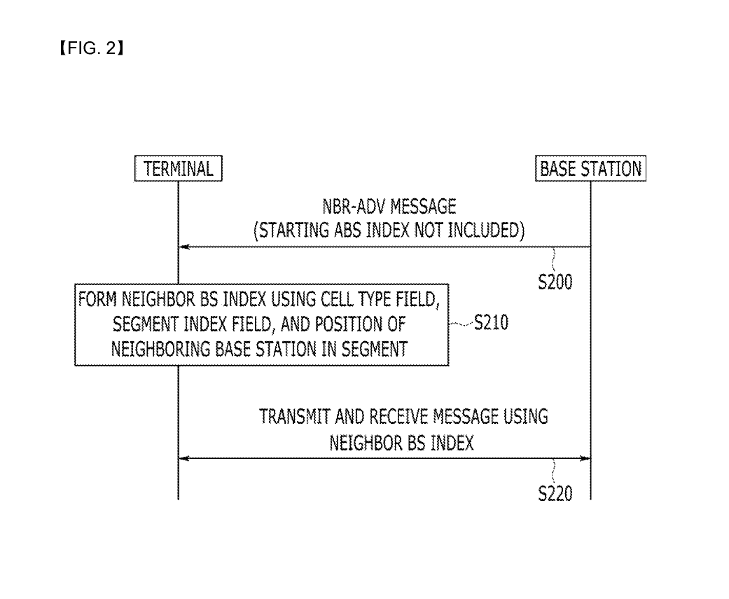

FIG. 2 is a flowchart that illustrates a method for transmitting an NBR-ADV message from a serving base station to a terminal in accordance with an exemplary embodiment of the present invention.

Referring to FIG. 2, a serving base station periodically broadcasts a NBR-ADV message to a terminal at step S200. The NBR-ADV message may be divided into a plurality of segments after being divided by a cell type. The NBR-ADV message includes a total number of cell type field, a cell type field, a total Number of AAI-NBR_ADV segment field, and an AAI-NBR_ADV segment field.

Unlike the AAI_NBR-ADV message shown in Table 1, the NBR-ADV message according to an exemplary embodiment of the present invention does not include a starting ABS index field.

The cell type may be classified into, for example, a macrocell, a microcell, a macro hotzone, a femtocell, and a relay. The total number of segment field denotes the total number of segments having the same cell type. The segment index field denotes a position or a sequence of a corresponding segment among the segments having the same cell type.

The terminal forms a neighbor BS index based on the cell type field, the segment index field, and the position of neighboring base station information in a segment S210. The position of the neighboring base station information in the segment means a sequence of a plurality of neighboring base station information included in one segment.

The neighbor BS index may be formed by combination of the cell type field, the segment index field, and the position of the neighboring base station information in a segment. For example, an index of the neighboring base station may be formed as at least one of m*n*k, m+n+k, and m/n/k, where m is a cell type, n is a segment index, and k is a position of corresponding neighboring base station information in a segment. These combinations are only an example, and the present invention is not limited thereto. The neighbor BS index may be obtained by a function having parameters of m, n, and k.

The terminal and the serving base station exchange messages using the neighbor BS index at step S220. Messages exchanged between the terminal and the serving base station may be an AA_SCN-REQ message, an AAI_SCN-RSP message, an AAI_DL-IM broadcast message, an AAI_LBS-ADV message, and an AAI_HO-REQ message. The AAI_SCN-REQ message is a message transmitted by the terminal to the serving base station for scanning a target base station for handover. The AAI_SCN-RSP message is a message transmitted by the serving base station to the terminal as a response to the AAI_SCN-REQ message. The AAI_DL-IM broadcast message is a message broadcasted by the serving base station to the terminal for the serving base station to decide a fractional frequency reuse (FFR) and multi input multi output (MIMO) parameter. The AAI_LBS-ADV message is a message broadcasted by a base station supporting a location based service (LBS) in order to broadcast information on the LBS. The AAI_HO-REQ message is a message transmitted by the terminal to the serving base station for requesting handover.

When the terminal and the serving base station exchange messages using the neighbor BS index, the terminal and the service base station may omit overlapped information in a neighbor BS index. For example, a neighbor BS to index is formed as m/n/k where m is a cell type, n is a segment index, and k is a position of corresponding neighboring base station information in a segment. A terminal wants to transmit a neighbor BS index 3/4/0 and a neighbor BS index 3/4/1. In this case, the terminal may transmit −/−/1 after transmitting 3/4/0. “−” means “not transmitted.”

Accordingly, a base station may convert −/−/1 to 3/4/1 when receiving −/−/1 after receiving 3/4/0. Accordingly, an amount of information for transmitting messages between a terminal and a base station can be reduced.

For this purpose, a serving base station may form a neighbor BS index using the same method of the terminal after transmitting a NBR-ADV message at the step S100. The terminal and the serving base station can discuss a method for forming a neighbor BS with each other beforehand.

As described above, the terminal forms a neighbor BS index using a position of neighboring base station information in a segment of a NBR-ADV message. Accordingly, the terminal can form a neighbor BS index even when the terminal does not receive a previous segment successfully. Furthermore, there is no necessary for the NBR-ADV message to include a starting ABS index per each segment.

Hereinafter, a method for transmitting superframe header (SFH) information per a carrier within a NBR-ADV message when multi-carrier is supported will be described.

Table 2 shows superframe header (SFH) information included in a NBR-ADV message in a wireless communication system supporting multi-carrier.

TABLE 2

| | | |
|---|---|---|
| BS number M | 8 | Total number of BSs |
| | | to be included in this |
| | | AAI_NBR-ADV |
| | | segment |
| for (i=0; i<M; i++) { | | |
| BSID | 48 | |
| Number of carriers (NC) | | Number of carriers of |
| for( j=0; j<NC ; j++) { | | the BS |
| SA-PREAMBLE index | 10 | |
| A-PREAMBLE transmit power | 8 | |
| Physical carrier index | 6 | Refer to the physical |
| | | carrier index in |
| | | AAI_Global-Config |
| | | message |
| MAC protocol versions | 8 | MAC protocol version of |
| | | the BS Consistent |
| | | with REV.2 definition, |
| | | with new MAC |
| | | protocol version |
| | | 9 defined for 16 m. |
| } | | |
| SFH_encoding_format | 2 | 0b00: full Subpkt |
| | | information |
| | | 0b01: delta encoding |
| | | (the 1st BS in this |
| | | cell type shall use full |
| | | Subpkt encoding) |
| | | 0b10: no SFH |
| | | included |
| | | 0b11: reserved |
| | | For macrocell ABS, |
| | | the bitmap shall be |
| | | either 0b00 or 0b01 |
| Control_bitmap | 4 | Each bit maps to one |
| | | SFH subpacket or |
| | | extended broadcast |
| | | information. For |
| | | macrocell ABS, |
| | | the bitmap shall be 1111 |
| If( SFH_encoding_format =00) { | | //encoding format type-1 |
| If( Control_bitmap[0] ==1 ){ | | |
| SFH Subpkt 1 | 88 | //exclude those fields |
| | | already in cell type info |
| } | | |
| If( Control_bitmap[1] ==1 ){ | | |
| SFH Subpkt 2 | 88 | //exclude those fields |
| | | already in cell type info |
| } | | |
| If( Control_bitmap[2] ==1 ){ | | |
| SFH Subpkt 3 | 88 | //exclude those fields |
| | | already in cell type info |
| } | | |
| } | | |
| If( SFH_encoding_format =01) { | | |
| Delta information | variables | Delta encoding, w.r.t. the |
| | | reference BS |
| } | | |
| Neighbor-specific trigger TLVs | variables | Optional neighbor- |
| | | specific triggers with |
| | | encoding defined in |
| | | Table 744- |
| } | | |

As shown in Table 2, only a SA-preamble index, an A-preamble transmit power, a physical carrier index, and a MAC protocol version are set per a carrier among SFH information in a NBR-ADV message when a base station supports NC multi-carriers. Accordingly, SFH subpacket (SFH subpkt) information is commonly set for all carriers.

In order to overcome such a problem, a method for forming SFH information in a NBR-ADV by a carrier when a serving base station support multi-carrier in accordance with an exemplary embodiment of the present invention will be described hereinafter.

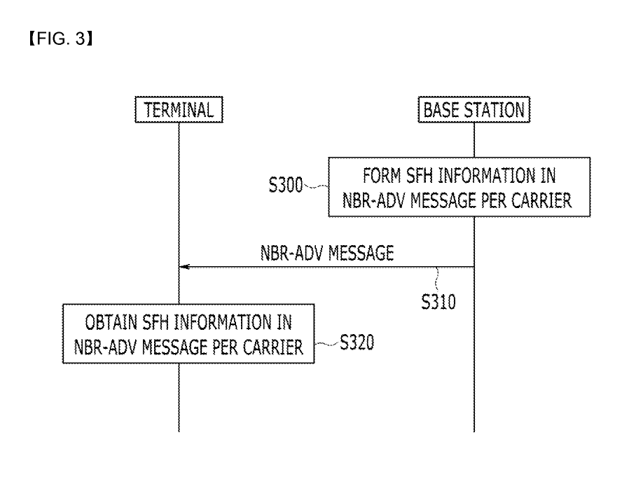

FIG. 3 is a flowchart that illustrates a method for transmitting a NBR-ADV message from a serving base station to a terminal in accordance with another exemplary embodiment of the present invention.

Referring to FIG. 3, a serving base station forms SFH information in a NBR-ADV message per each carrier at step S300 and periodically broadcasts the NBR-ADV message to a terminal at step S310. Table 3 shows a part of a NBR-ADV message in accordance with an exemplary embodiment of the present invention.

TABLE 3

| | | |
|---|---|---|
| BS number M | 8 | Total number of BSs to |
| | | be included in this |
| | | AAI_NBR-ADV |
| | | segment |
| for (i=0; i<M; i++) { | | |
| BSID | 48 | |
| Number of carriers (NC) | | Number of carriers of the |
| for( j=0; j<NC; j++) { | | BS |
| SA-PREAMBLE index | 10 | |
| A-PREAMBLE transmit power | 8 | |
| Physical carrier index | 6 | Refer to the physical |
| | | carrier index in |
| | | AAI_Global-Config |
| | | message |
| MAC protocol versions | 8 | MAC protocol version of |
| | | the BS Consistent with |
| | | REV.2 definition, with |
| | | new MAC protocol |
| | | version 9 defined for |
| | | 16m. |
| SFH_encoding_format | 2 | 0b00: full Subpkt |
| | | information 0b01: delta |
| | | encoding (the 1st BS |
| | | in this cell type shall use |
| | | full Subpkt encoding) |
| | | 0b10: no SFH included |
| | | 0b11: the SFH encoding |
| | | is the same as those of |
| | | the preceding carrier |
| | | For macrocell ABS, the |
| | | bitmap shall be either |
| | | 0b00 or 0b01 |
| Control_bitmap | 4 | Each bit maps to one |
| | | SFH subpacket or |
| | | extended broadcast |
| | | information. |
| | | For macrocell ABS, |
| | | the bitmap shall be 1111 |
| If( SFH_encoding_format =00) { | | //encoding format type-1 |
| If( Control_bitmap[0] ==1 ){ | | |
| SFH Subpkt 1 | 88 | //exclude those fields |
| | | already in cell type info |
| } | | |
| If( Control_bitmap[1] ==1 ){ | | |
| SFH Subpkt 2 | 88 | //exclude those fields |
| | | already in cell type info |
| } | | |
| If( Control_bitmap[2] ==1 ){ | | |
| SFH Subpkt 3 | 88 | //exclude those fields |
| | | already in cell type info |
| } | | |
| } | | |
| If( SFH_encoding_format =01) { | | |
| Delta information | variables | Delta encoding, w.r.t. the |
| | | reference BS |
| } | | |
| Neighbor-specific trigger TLVs | variables | Optional neighbor- |
| | | specific triggers with |
| | | encoding defined in |
| | | Table 744- |
| } | | |
| } | | |

As shown in Table 3, entire SFH information in the NBR-ADV message is set per each carrier. For example, a SA-preamble index, an A-preamble transmit power, a physical carrier index, a MAC protocol version, and SFH sub_packet (SFH subpkt) information are set according to each carrier. The NBR-ADV message may be related to, for example, same to SFH subpkt information of a previous carrier when a SFH_encoding_format is set as 0b11.

The terminal obtains SFH information in the NBR-ADV message per each carrier at step S320. That is, the terminal can obtain SFH subpkt information per each carrier as well as a SA-preamble index, an A-preamble transmit power, a physical carrier index, and a MAC protocol version. When the SFH_ending_format is set as 0b11 in the NBR-ADV message, it may be interpreted as that the NBR-ADV message may be related to SFH subpkt information of a previous carrier.

The serving base station can set entire SFH information in the NBR-ADV message per each carrier, and the terminal can obtain entire SFH information in the NBR_ADV message per each carrier.

The apparatus and method according to an exemplary embodiment of the present invention described above can be realized as a program performing to functions corresponding to configuration elements of the apparatus and method or as a computer readable recording medium storing the program. Since the realization can be easily implemented by those skilled in the art to which the exemplary embodiment of the present invention pertains, further description will not be provided herein.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for obtaining superframe header (SFH) information in a neighboring base station advertisement (NBR-ADV) message at a terminal, the method comprising:
receiving a NBR-ADV message having SFH information set per each carrier from a serving base station; and
obtaining the SFH information of each carrier per carrier from the NBR-ADV message,
wherein in the obtaining the SFH information of each carrier, SFH information of a corresponding carrier is obtained based on SFH information of a previous carrier when a predetermined field is set as a predetermined value.

2. The method of claim 1, wherein the predetermined field is a superframe header encoding format (SFH_encoding_format) field, and the predetermined value is 0b11.

3. The method of claim 1, wherein the SFH information includes sub_packet information of a superframe header.

4. A method for transmitting a neighboring base station advertisement (NBR-ADV) message at a serving base station supporting multi-carrier, the method comprising:
setting superframe header (SFH) information in the NBR-ADV message per carrier; and
periodically broadcasting the NBR-ADV message to a terminal,
wherein in the setting SFH information, a predetermined field is set as a predetermined value when SFH information of a first carrier is related to SFH information of a second carrier that is a previous carrier of the first carrier.

5. The method of claim 4, wherein the predetermined field is a superframe header encoding format (SFH_encoding_format) field, and the predetermined value is 0b11.

6. The method of claim 4, wherein the SFH information includes sub_packet information of a super frame header.

7. A method for obtaining a neighbor base station (BS) index at a terminal, the method comprising:
receiving a neighboring base station advertisement (NBR-ADV) message from a serving base station, wherein the NBR-ADV message includes cell type information, message segment index information, and at least one of neighboring base station information; and
configuring a neighbor BS index by combining the cell type information, the message segment index information, and a position of corresponding neighboring base station information.

8. The method of claim 7, wherein the cell type is at least one of a macrocell, a microcell, a macro hotzone, a femtocell, and a relay.

9. The method of claim 7, wherein the position of corresponding neighboring base station information denotes a sequence of corresponding neighboring base station information in a message segment.

10. The method of claim 7, wherein the message segment is configured per each cell type.

11. The method of claim 7, wherein the neighbor BS index is obtained from a function having parameters of a value related to a cell type, a value related to a message segment, and a value related to a position of corresponding neighboring base station information.

12. The method of claim 7, wherein the neighbor BS index is obtained by using sum of a value related to a cell type, a value related to a message segment, and a value related to a sequence of corresponding neighboring base station information.

13. The method of claim 7, further comprising:
discussing about a method for configuring the neighbor BS index with the serving base station.

14. The method of claim 7, further comprising:
transmitting a scanning request message including the neighbor BS index to the serving base station.

15. The method of claim 14, wherein when the scanning request message includes a plurality of neighbor BS indexes, at least one overlapped value among a value related to the cell type, a value related to the message segment, and a value related to the position of corresponding neighboring base station information is omitted.

16. A method for obtaining a neighbor base station (BS) index of a service base station, the method comprising:
setting a neighboring base station advertisement (NBR-ADV) message including cell type information, message segment index information, and neighboring base station information;
periodically broadcasting the NBR-ADV message; and
configuring a neighbor base station (BS) index by combining the cell type information, the message segment index information and a position of neighboring base station information.

17. The method of claim 16, wherein the position of the neighboring base station information denotes a sequence of neighboring base station information within a message segment.

18. The method of claim 16, further comprising:
receiving a scanning request message including the neighbor BS index from a terminal; and
transmitting a scanning response message including the neighbor BS index as a response to the scanning request message to the terminal.

19. The method of claim 16, wherein a message for broadcasting multi input multi output (MIMO) parameters or a message for broadcasting location based service (LBS) information is transmitted to the terminal by using the neighbor BS index.
